(19) United States
(12) Patent Application Publication
(10) Pub. No.: US 2012/0066750 A1
(43) Pub. Date: Mar. 15, 2012

(54) USER AUTHENTICATION AND PROVISIONING METHOD AND SYSTEM

(76) Inventors: Douglas McDorman, Sammamish, WA (US); Rex Wheeler, Portland, OR (US)

(21) Appl. No.: 12/880,435

(22) Filed: Sep. 13, 2010

(51) Int. Cl. H04L 9/32; G06F 21/00

(52) U.S. Cl. 726/7

(57) ABSTRACT

Disclosed are methods and systems to authenticate and provision new, unknown users into a computer network. A computer program utilizes a card reader to extract user information from a smart card and collect additional user information inputted by the user into a computer terminal. The computer program analyzes the secure electronic certificate extracted from the smart card to authenticate the user's credentials, and transmits the user information securely to a user provisioning application. Moreover, methods and systems consistent with the present invention, utilize secure communication protocols to enable the computer program to pass the user information from an unsecured area outside of a computer network perimeter through a network firewall to a secure provisioning application inside the computer network.

### FIELD OF INVENTION

The invention relates generally to authentication of a user outside the perimeter of a local computer network and will be specifically disclosed in connection with a system for retrieving, extracting, processing, and analyzing user credentials to authenticate and provision the user into the local computer network.

### BACKGROUND OF THE INVENTION

The adoption and implementation of computer networks continues to multiply at an exponential rate. Today, organizations from private enterprises to governmental agencies have adopted and implemented sophisticated computer networks many times larger, faster, and more efficient than their predecessors. The networks often include a vast array of email servers, database systems, application servers, web servers, workstations, printers and print servers, and other systems and devices all interconnected through the computer network. Additionally, the latest generation of computer networks are infinitely more complex and incorporate layers of technologies and methodologies including encryption, biometrics, defensive programming, ID cards, trusted computing, and many other devices and schemes to secure data that is stored on the network, transmitted to or from the network, and to regulate access to and use of the network.

One of the most routine yet important tasks undertaken by network administrators is that of authenticating a new employee, contractor, or individual into the network and providing the individual with access to various systems and applications necessary for the individual to perform his/her duties. This “provisioning” process often includes granting the new user access, that is appropriate for that user's position and role in the organization, to the necessary file servers, email accounts, database systems, printers, and applications throughout the network, each of which may implement its own security system including usernames, passwords, or other protocols.

A conventional computer network configuration used to simplify this provisioning process calls for consolidating separate networks and computer domains into one large network with a limited or even a single network security and user authentication process in order to efficiently grant network access to users and applications as well as consolidating network management processes to increase security by limiting the number of potential access points and unifying network security protocols throughout the entire organization.

In the conventional process, when an individual would need access to a computer network controlled by an organization, an employee of the organization would start the provisioning process either manually or electronically submitting the new user's verified credentials (such name, rank/position, and other identifying information) to the network administrator. Based upon pre-established protocols outlining the necessary access to systems and data that a user with such credentials should receive, the network administration may then create a network “log on” (such as username or password) to authenticate the user to the computer network and grant various system and file privileges to the user in order to enable the user to use certain machines, applications, and access various data throughout the entire organization. Utilizing this consolidated conventional network structure, this provisioning process could be completed within a few hours, after which the user would have all the necessary access throughout the entire organizational structure.

Although these consolidated computer network models have many benefits including efficiency, lower costs, increased commonality, and others, this model may not be appropriate for every type of organization. Many large organizations or government entities, either due to their sheer size, history of acquisitions of other organizations with differing technologies, or organizational, governmental, or legal restrictions or requirements, operate a multitude of separate and distinct computer networks each with its own provisioning process for users in need of accessing each network. Managing and securing these disparate computer networks can often times be costly, time consuming, and exceedingly difficult. Not to mention the difficulty in quickly provisioning a new and previously unknown and unauthenticated user or an existing user who needs access to a new network.

An example of this disparate computer network system is the U.S. Military's implementation of network security throughout the U.S. Military base network. Traditionally, although all U.S. Military bases are generally “interlinked” with the Department of Defense (DoD) and thus indirectly connected to all other bases, stations, and U.S. Military command by various computer network links, the process of provisioning a single user, such a soldier, into a base's computer network is uniquely handled by the computer network administrator located on each U.S. Military base.

Due to the obvious heightened security requirements and, as a result, the U.S. Military's priority of security over cost or efficiency with regards to computer network implementation and design, each U.S. Military base utilizes a segmented and disparate network structure, and generally prohibit all unauthenticated users from accessing the Local Network. For example, each base may have separate or unique computer networks, domains, administrative staff, email servers, security procedures and protocols, and software systems. Although this autonomy may lower the risk that a security intrusion at one base exposes another base or the entire DoD network to that threat, it creates substantial operational obstacles to overcome impacting even the most routine events; for example, provisioning a soldier transferring from base A to base B. To date, there is no efficient, system wide, and automated credentialing process to provision a previously unknown individual's access to a U.S. Military base. The current process of provisioning access to U.S. Military bases or facilities to an individual takes a tremendous amount of time and effort to (i) complete and process individual provisioning application; (ii) coordinate with DoD to verify the individual's credentials; and (iii) grant the individual access to the base and the applicable computer systems. The current provisioning process to authenticate a new user, create the applicable user accounts to the various military computer systems, and grant the individual access to such systems takes on average two to three weeks. Despite these disjointed systems, DoD personnel do share one common badge-based system—the DoD has issued every U.S. Military personnel a Common Access Card (CAC) containing personally identifying information about the individual including the individual's verified credentials and the DoD electronic trusted certificates.

There is thus a general need in the art for a system capable of capturing user information outside of the computer network perimeter and leveraging this information to provision users into a new computer network, in a timely, accurate, and efficient manner.

### SUMMARY OF THE INVENTION

Disclosed is a computer network authentication system for verifying the authenticity of user credentials to access a computer network, and provisioning the user into the computer network which is a part of a larger network of computer networks which are separate and segregated from each other. The system is comprised of a computer processing device comprising memory configured to store computer executable instructions and a processor in communications with the memory, wherein the processor is configured to execute computer software. The software is enabled to (i) obtain user data from the user to access and use the computer network and (ii) securely transmit the user data through a network perimeter to a provisioning application software program. The provisioning application is enabled to authenticate the user data and communicate the user data to a Identity Management and Provisioning System; which is enabled to provision the user into the computer network.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 is a block diagram of a computer processing device consistent with the principles of the present invention; and

FIG. 2 is a network diagram showing one example of a Global Network comprised of decentralized, segregated, self-contained Local Networks consistent with the principles of the present invention; and

FIG. 3 is a network diagram showing one exemplary method of utilizing a card reader and computer processing device capable of extracting, capturing, and transmitting electronic information consistent with the principles of the present invention; and

FIG. 4 is a flow chart showing one exemplary method of extracting, translating, securing, storing, transmitting, organizing, and processing of electronic data in order to authenticate and provision a user of a computer network.

### DETAILED DESCRIPTION OF THE INVENTION

Reference will now be made in detail to the present embodiments of the invention, examples of which are illustrated with reference to the accompanying drawing(s). Wherever possible, the same reference numbers will be used throughout the drawings to refer to the same or like parts.

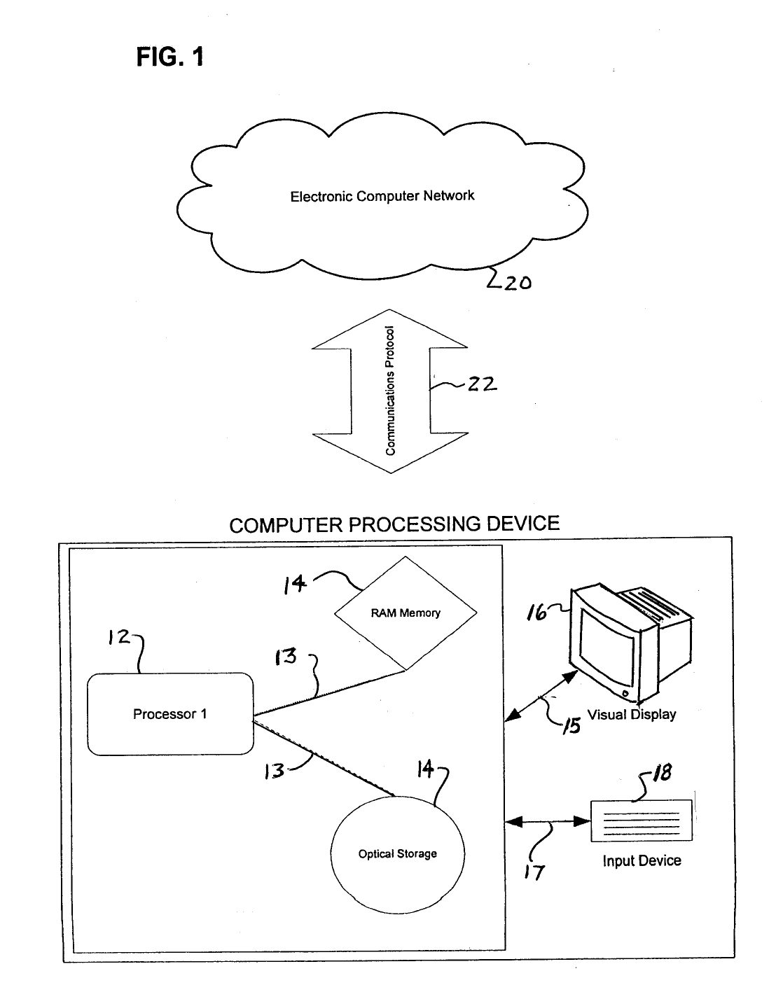

FIG. 1 is a block diagram of a computer processing device 10 through the use of computer software capable of (i) extracting, storing, translating, securing, transmitting, and processing computer network user (User) information including demographic information, personally identifying information, security credentials, and other information in electronic format and (ii) transmitting that electronic data (User Data) to other computer processing devices over an electronic computerized communications link (communications link) to verify the User's credentials in order to grant the User access to various data, computer servers, software programs, and other facilities located in and interconnected with a computer network by initiating an electronic process for authenticating the User and providing the User with the appropriate network access. A method consistent with the present invention comprises a computer processing device 10 comprised of a computer processor 12 and memory 14 coupled by a communications link 13 between the computer processor and memory. The computer processor 10 may represent one or more computer processors capable of executing computer code to perform various tasks such as extracting, organizing, retrieving, and processing data. Memory 14 may be one or more devices capable of temporarily or permanently storing data, and such memory may comprise RAM, ROM, magnetic storage, optical storage, or other electronic storage medium or method. A method consistent with the present invention comprises an electronic computer network 20 enabling the computer processing device 10 to access local or remote data storage devices in order to collect discrete data. The computer processing device 10 is (i) electronically linked 15 to a computer visual display 16 capable of displaying human readable content and (ii) electronically linked 17 to a human usable information input device 18; one example of which may be a keyboard. The electronic computer network 20 comprises either the ability to communicate over Internet Protocol or other computer communications protocol 22 capable of facilitating the transmission of data between one computer network and another and from one computer processing device to another.

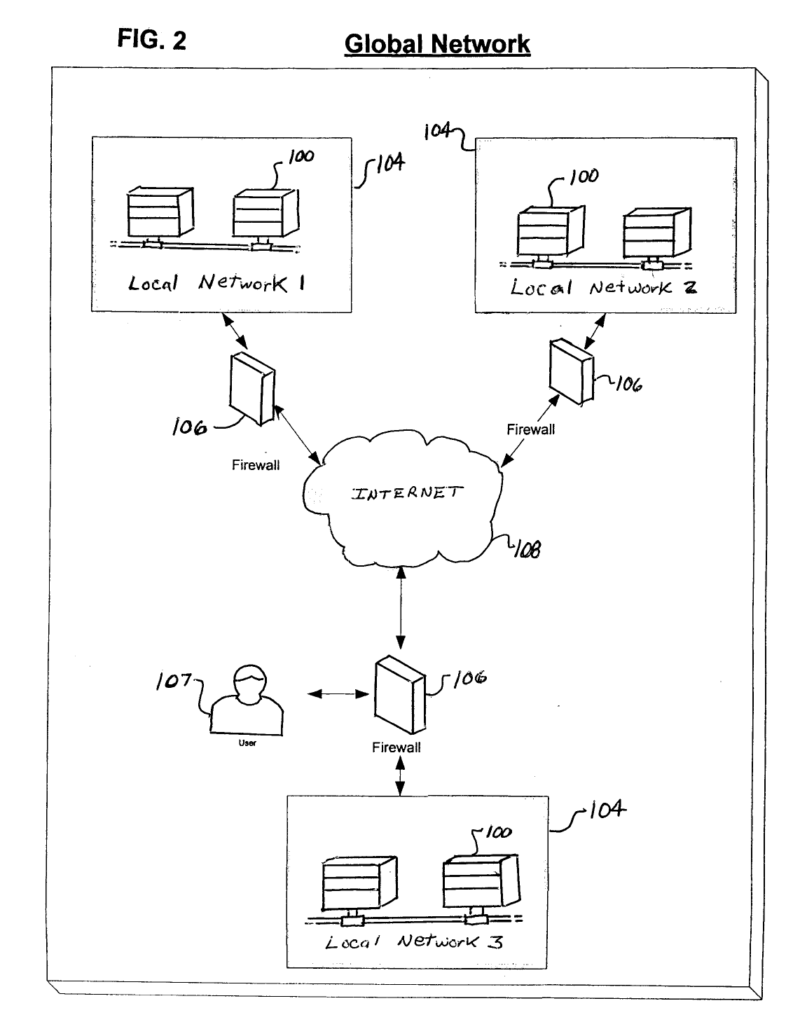

As shown in FIG. 2, one embodiment of the invention includes an electronic and computerized system enabled to authenticate a User 107 outside of a computerized network perimeter 106 and (upon authentication) to provide that User 107 with access to various systems, software programs, devices, and other facilities located in or accessible through an organization's computer network. The organization's computer network system is comprised of disparate, separate and unique computer networks (Local Networks) 100 and only generally interconnected through a communications link 108 to the organization's entire network infrastructure (Global Network) 102. One embodiment of the invention is comprised of each physical location 104 of the organization having its own Local Network 100, which has an electronic, computerized perimeter 106 preventing unauthorized access. One embodiment of the invention is comprised of the User 107 initiating a computer network access request to a Local Network 100 within an organization's Global Network 102. Each Local Network 100 has separate and distinct software applications, network structures and protocols, email systems, domains, and user authentication protocols and are otherwise separate and unique computer networks.

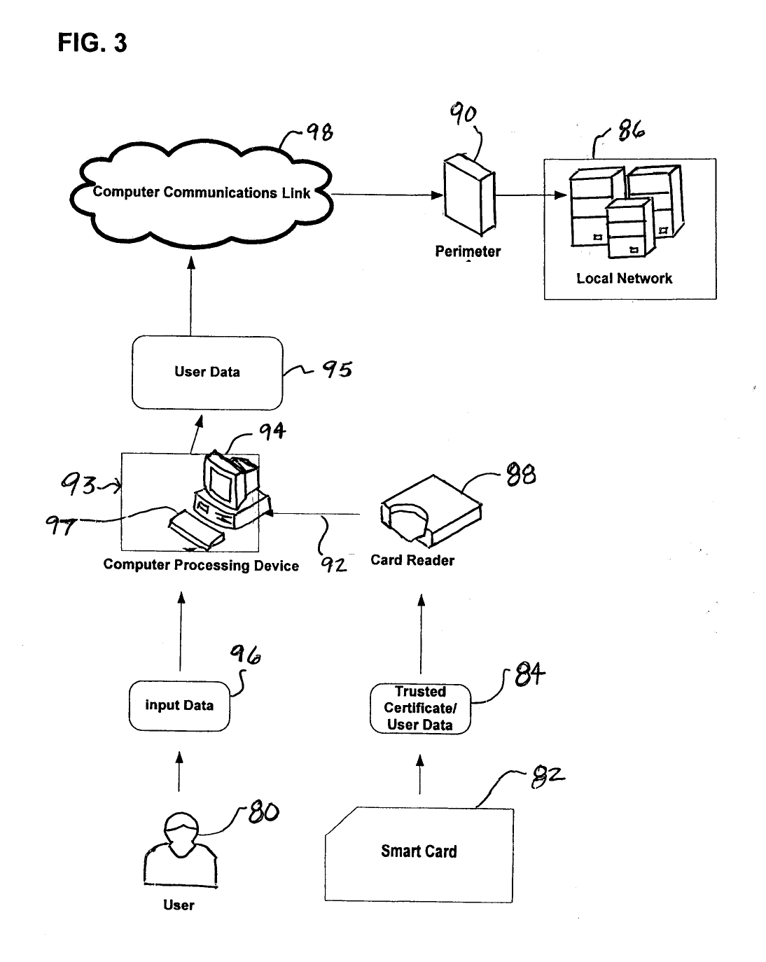

As shown in FIG. 3, one exemplary embodiment of the invention comprises the User 80 initiating an access request by passing User Data 84 to the Local Network 86 through a physical modality, one embodiment of this is the use of a personal identification electronic storage card (Smart Card) 82, which may contain an electronic microchip or similar technology capable of storing secured information. “Secured” means protected through the use of encryption, digital signatures, or the similar technologies or methodologies. The User 80 passes User Data 84 through the Smart Card 82 by interfacing the Smart Card 82 with a Smart Card reading device (Card Reader) 88. User Data contained on the Smart Card could include name, government identification number, email address, rank, blood type, or the like. One example of a suitable Smart Card 82 is the CAC issued by the United States Department of Defense. The specific functionality, configuration, and use of the CAC is further described on the Department of Defense website http://www.cac.mil, which is incorporated in and constitutes a part of this specification. The Smart Card 82 includes a secured and electronically verifiable certificate (Trusted Certificate) 84 created and issued by the organization, or by a third party which is trusted by the organization to create such certificates. One example of the Trusted Certificate 84 is through the use of X.509 client certificate authentication. The specific functionality, configuration, and use of the X.509 authentication standard is further described in the “Series X: Data Networks, Open System Communications and Security—ITU-T Recommendation X.509” published August 2005, which is incorporated in and constitute a part of this specification. It is noted that any other suitable client certificate authentication can alternatively be utilized. One exemplary implementation of the invention includes embedding X.509 Trusted Certificates on the Smart Card 82, which include trusted credential 84 information related to the User 80. The Trusted Certificate 84 correlates with predetermined permitted access criteria. The User 80 desiring to receive access to the Local Network 86 inserts the preloaded Smart Card 82 into the Card Reader 88 outside of the perimeter 90 of Local Network 86. One exemplary implementation of this process comprises the Card Reader's 88 ability to communicate User Data 84 and the Trusted Certificate 84 to the computer processing device 93 to verify the digital signature of User Data 84 and Trusted Certificate 84 preloaded onto the Smart Card 82. The computer processing device 93 would be enabled to securely transmit the User Data 84 and Trusted Certificate 84 from the Card Reader 88 over communications link 92. The computer processing device 93 would be enabled to utilize computer software programmed to verify the Trusted Certificate's 84 authenticity. If the Trusted Certificate 84 is verified and validated as a trusted source, the computer processing device 93 visually presents the User Data 84 on a visual display 94 readable by the User 80. One embodiment of the visual display 94 would be a computer processing terminal or screen. The computer processing device incorporates the ability to query and request from the User 80 additional User Data 96, if predetermined elements of information are not otherwise extracted from the Smart Card 82. One example of additional User Data includes a personal identification number, passcode, pass phrase, or the like. The User 80 inputs any additional User Data 96 into the computer processing device 93 by accessing a user input device 97 (one example of which would be a computer keyboard) connected to the computer processing device 93. Upon receipt of the additional User Data 96, the computer processing device 93 is enabled to compile the User Data 84 from the Smart Card 82 and any additional User Data 96 and transmit this User Data 95 over a computer communications link 98 through the Local Network Perimeter 90 to the Local Network 86.

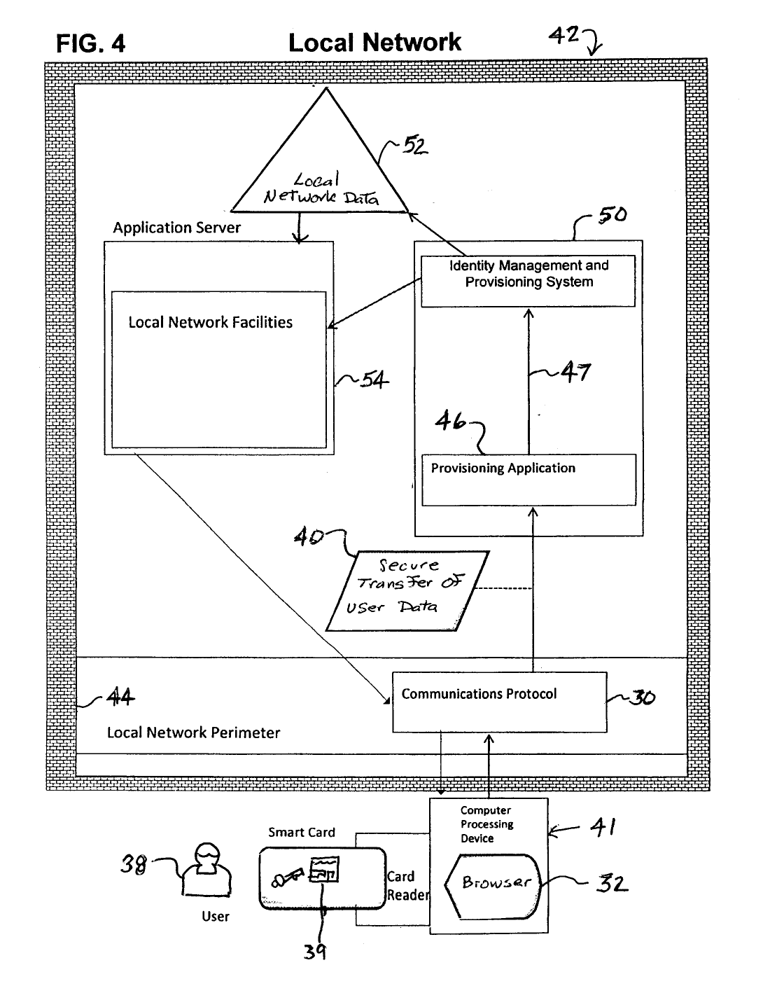

One exemplary implementation of the invention may be consistent with the steps illustrated in the flowchart of FIG. 4. Other alternative steps may be employed and that the particular order of events may vary without materially departing from the scope of the present invention. Furthermore, certain steps may not be present in FIG. 4 and additional steps may be added without departing from the spirit of the invention claimed herein.

As shown in FIG. 4, one exemplary implementation of the invention comprises the computer processing device's 41 use of computer software program (Provisioning Application) 46 compatible with an Internet web browser (Browser) 32 to extract information from the Card Reader 34 extracted from a Smart Card 36 presented by the User 38. The Provisioning Application 46 is programmed to verify the Trusted Certificate's 39 authenticity of the User 38 for access to the Local Network 42.

As shown in FIG. 4, one embodiment of the present invention is comprised of the Provisioning Application 46 enabled to securely transmit the User Data 40 from outside the Local Network Perimeter 44 to the Provisioning Application 46 within the Local Network 42. The present invention uses a secure electronic communications protocol (Communications Protocol) 30 capable of securing communications between a plurality of software programs and between a plurality of computer processing devices over a communications link. One exemplary implementation of the Communications Protocol 30 is enabled using the computer software code by Microsoft, Inc. (Microsoft) known as the Internet Security and Acceleration (IAS) server application and the Intelligent Application Gateway (IAG) server application to create a secure communications link between the User 38 outside the Local Network perimeter 44 and the Provisioning Application 46, which may be executed on separate and distinct computer processing devices. The specific functionality, configuration, and use of the IAS application is further described in the “Secure Remote and Outbound Internet Access Using ISA Server 2006 Web Proxy—White Paper” published June 2006, which is incorporated in and constitute a part of this specification. The specific functionality, configuration, and use of the IAG application is further described in the “Intelligent Application Gateway: A Technology and Features Overview—White Paper” published February 2007, which is incorporated in and constitutes a part of this specification. It is noted that any other suitable Communications Protocol 30 can alternatively be utilized. One embodiment of the present invention incorporates the use of Microsoft's Internet Server Application Programming Interface (ISAPI) filter to securely transmit the User Data 40 through the Communications Protocol 30 to the Provisioning Application 46. One embodiment of the invention includes the use computer software within the Provisioning Application 46 configured to use an ISAPI filter through the Communications Protocol 30 to pass information extracted from the X.509 Trusted Certificate 39 and the Smart Card 36 presented outside of the Local Network perimeter 44 to the Provisioning Application 46 inside of the Local Network perimeter 44. The specific functionality, configuration, and use of an ISAPI filter that is available as a part of Microsoft's Internet Information Services (IIS) and is further described at http://www.iis.net, which is incorporated in and constitutes a part of this specification. It is noted that any other suitable firewall filter can alternatively be utilized.

As shown in FIG. 4, in embodiments consistent with the present invention, the Provisioning Application 46 would establish a communications link 47 with an identity management and local user access control system (Identity Management and Provisioning System) 50. One embodiment of the invention would be that the Identity Management and Provisioning System would be executed on a separate computer processing device within the Local Network perimeter. One embodiment consistent with the present invention, utilizes the use of the Microsoft ForeFront Identity Manager (FIM) software program as the Identity Management and Provisioning System 50. The specific functionality, configuration, and use of FIM is further described in the “Understanding Microsoft Forefront Identity Manager 2010” published in October 2009, which is incorporated in and constitutes a part of this specification. It is noted that any other suitable Identity Management and Provisioning System can alternatively be utilized.

As shown in FIG. 4, one embodiment of the invention includes the Provisioning Application 46 enabled to transmit the User Data 40 collected from the User 38 and the Smart Card 36 and transmit that information through the Communications Protocol 30 over to the Provisioning Application 46. The Identity Management and Provisioning System 50 would be configured to receive the User Data 40 from the Provisioning Application 46 and create an electronic work flow process. One embodiment of the invention includes the Identity Management and Provisioning System 50 configured to (i) automatically process the User access request queue sequentially as each User request is submitted and (ii) automatically create the necessary User accounts and granting the necessary User access to the Local Network Data 52 and the Local Network Facilities 54 such as applicable software, servers, buildings, rooms, devices and other facilities appropriate for the User 38 based upon the User's credentials.

One embodiment of the invention is comprised of the computer network and security infrastructure of the U.S. Military. In this example, the Smart Card is the Common Access Card (CAC) issued by the Department of Defense (DoD) to all U.S. Military personnel containing personally identifying information, credentialing information, and a Trusted Certificate secured and embedded in to the CAC. One example of this process would include a U.S. Military office transferring bases and utilizing their CAC to initiate a request for authentication onto a new base's Local Network.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation may be implemented as a combination of hardware and software or in hardware alone.

What is claimed is:

1. A computer network authentication system for verifying the authenticity of user credentials to access a computer network, and provisioning the user into the computer network, the system comprising:
a computer processing device comprising memory configured to store computer executable instructions and a processor in communications with the memory, wherein the processor is configured to execute computer software enabled to:
obtain user data from the user to access and use the computer network;
securely transmit the user data through a network perimeter to a provisioning application, the provisioning application enabled to verify the user data and communicate the user data to a Identity Management and Provisioning System; and
the Identity Management and Provisioning System enabled to provision the user into the computer network.

2. The system of claim 1, wherein a smart card is enabled to store the user data.

3. The system of claim 1, further comprised of a smart card reader, where the smart card reader is enabled to read the user data from the smart card and transmit the user data to the computer processing device.

4. The system of claim 2, wherein a portion of the user data stored on the smart card includes a secured and electronically verifiable certificate.

5. The system of claim 2, wherein the user data stored on the smart card includes name, government identification number, and email address.

6. The system of claim 1, wherein a human-readable display is interlinked to the computer processing device and enabled to display the user data.

7. The system of claim 1, wherein a human-usable input device is interlinked to the computer processing device and enabled to communicate additional user data to the computer processing device that is inputted into by the user.

8. The system of claim 7, wherein the additional user data is a personal identification number.

9. The system of claim 1, wherein the user data is transmitted through a communications protocol to the provisioning application.

10. A method for verifying the authenticity of user credentials to access a computer network, and provisioning the user into the computer network, comprising the steps of,
obtaining user data from the user to access and use the computer network;
securely transmitting the user data through a network perimeter to a provisioning application enabled to verify the user data and communicate the user data to a Identity Management and Provisioning System; and
provisioning the user into the computer network via the Identity Management and Provisioning System.

11. The method of claim 10, wherein a smart card is enabled to store the user data.

12. The method of claim 11, wherein a smart carder reader is enabled to read the user data from the smart card and transmit the user data to the computer processing device.

13. The method of claim 11, wherein a portion of the user data stored on the smart card includes a secured and electronically verifiable certificate.

14. The method of claim 11, wherein the user data stored on the smart card includes name, government identification number, and email address.

15. The method of claim 10, wherein a human-readable display is interlinked to the computer processing device and enabled to display the user data.

16. The method of claim 10, wherein a human-usable input device is interlinked to the computer processing device and enabled to communicate additional user data to the computer processing device that is inputted into by the user.

17. The method of claim 16, wherein the additional user data is a personal identification number.

18. The method of claim 10, wherein the user data is transmitted through a communications protocol to the provisioning application.
